(19) United States
(12) Patent Application Publication
(10) Pub. No.: US 2009/0040023 A1
(43) Pub. Date: Feb. 12, 2009

(54) RF Transponder for Off-Line Authentication of a Source of a Product Carrying the Transponder

(75) Inventor: Albertus Jacobus Pretorius, Pretoria (ZA)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: IPICO INNOVATION INC, Aurora, ON (CA)

(21) Appl. No.: 11/662,561

(22) PCT Filed: Sep. 6, 2005
(86) PCT No.: PCT/IB05/52906

§ 371 Date: Apr. 4, 2008

(30) Foreign Application Priority Data
Sep. 14, 2004 (ZA) 2004/7360

(51) Int. Cl. H04Q 5/22

(52) U.S. Cl. 340/10.1

(57) ABSTRACT

A transponder (28) of a radio frequency identification (RFID) system comprises control circuitry, a response signal generating arrangement and a memory arrangement (22) connected to the control circuitry. The memory arrangement comprises at least a first part (42) and a second part (44). The first part (42) comprises unique identification data (UID) (70) relating to the transponder and which is permanently stored in the first part of the memory arrangement at manufacture of the transponder. The second part (44) is configured to be written to, after manufacture of the transponder. The control circuitry is configured, after energization of the transponder, to cause the response signal generating arrangement automatically to generate a first response signal modulated with data in the first part and data in the second part, to be transmitted by the transponder.

This invention relates to radio frequency identification (RFID) systems. It more particularly relates to a transponder for an RFID system.

It is well known to use RFID systems for electronically counting and identifying products or articles. In the known systems, transponders of the system are provided as part of tags on respective host articles. A reader is used to energize and/or interrogate the transponders. The transponders respond with respective response signals and the reader receives these signals and extracts therefrom respective transponder identification (ID) data, thereby to count and/or identify the articles. For vehicles, ID data in the form of a Vehicle Identification Number (VIN) comprising a set of data describing the type of vehicle and a unique serial number is used. For supply chain products, there is used an Electronic Product Code (EPC) comprising a product code and a serial portion generated by the manufacturer or source of the product according to certain guidelines and standards.

In both these cases, there is no guarantee for the uniqueness of the VIN or EPC, if blank and programmable transponders are used by the source. The transponders or tags can be cloned by simply procuring a blank transponder and programming it with a VIN or EPC obtained from an existing and genuine transponder. It is clear that, unless an online database is queried, the source of a programmed transponder cannot be verified. This presents a problem with pirate goods, illegal vehicle licences and false seals on containers and documents. A further problem with the known systems is that the data in the transponder memory arrangement may later fraudulently be changed. Various proposals to solve this problem through the use of complex handshaking protocols between the reader and the transponders and passwords have been made. All these proposals use shared secrets and secret algorithms to create privacy. These depend on the effectiveness of the secrecy and have proven to fail in many cases. Furthermore, handshaking protocols take up too much time and are not suitable for practical automated systems with dynamic populations of articles. Still furthermore, when more than one interrogating reader is used in the same area, which often is required in supply chain applications where large volumes of articles need to be identified and/or verified, unnecessary interference between the interrogation signals are problematic.

### OBJECT OF THE INVENTION

Accordingly, it is an object of the present invention to provide an alternative radio frequency transponder, radio frequency identification (RFID) system, an article tagging station, a verifying device, a method of tagging an article and a method of reading a transponder with which the applicant believes the aforementioned disadvantages may at least be alleviated.

### SUMMARY OF THE INVENTION

According to the invention there is provided a transponder of a radio frequency identification (RFID) system, the transponder comprising control circuitry, a response signal generating arrangement and a memory arrangement connected to the control circuitry; the memory arrangement comprising at least a first part and a second part; the first part comprising unique identification data (UID) relating to the transponder and which is permanently stored in the first part of the memory arrangement at manufacture of the transponder; the second part being configured to be written to, after manufacture of the transponder; and the control circuitry being configured after energization of the transponder, to cause the response signal generating arrangement to generate a first response signal modulated with data comprising data in the first part and data in the second part, to be transmitted by the transponder.

The transponder may be a passive or semi-passive transponder which in use derives power to energize the transponder from an energization signal transmitted by the reader.

After being energized by the energizing signal, the transponder automatically transmits the first response signal without being interrogated by the reader. In a preferred embodiment of the invention there is no handshaking between the reader or verifier and the transponder in that the transponder talks only (TTO) by automatically transmitting and intermittently retransmitting the first response signal.

The data in the first part may be locked into, burnt into or otherwise permanently written and stored in the first part. Any effort subsequently to change this data, would result in the transponder being damaged.

A signer device may be utilized at a source of an article carrying a tag comprising the transponder to write or program the second part data to the second part of the memory arrangement of the transponder. Thereafter, the second part data may also be locked into the memory arrangement.

The memory arrangement may comprise a third part for storing third part data which is not transmitted in the first response signal. The third part may be configured to be read and repeatedly to be written to by the control circuitry.

The control circuitry may be configured to write data received from an external device to the third part of the memory arrangement; and in response to an interrogation signal received from an external interrogating device, to cause a second response signal comprising data retrieved from the third part to be transmitted.

The first, second and third parts of the memory arrangement may be embodied in EEPROM. The memory arrangement may hence comprise a single body of EEPROM divided into at least the first and the second parts and preferably also the third part. In other embodiments, separate memory blocks or bodies may be utilized.

Also included within the scope of the present invention is an RFID system comprising a plurality of transponders as hereinbefore defined; and a signer device which is utilized at a source of an article carrying one of the transponders to write into the second part of the memory arrangement second part data.

The second part data may comprise data resulting from mathematical processing of at least two of the first part data, data relating to the source, and data relating to the article. The processing may comprise encryption, preferably asymmetric encryption.

The data relating to a source may be a source identification code (SID). The SID may be linked to an encryption key pair, one key of the pair being utilized in the encryption.

The data relating to the article may comprise one or more of an electronic product code (EPC), a vehicle identification number (VIN) and digital data relating to a unique feature of the article.

Also included within the scope of the present invention is an article tagging station at a source of an article to be provided with a transponder as hereinbefore defined, the station comprising a signer device comprising a processor for generating second part data and writing the second part data into the second part of the memory arrangement of the transponder.

The processor may comprise an encryption key pair generator for generating a pair of encryption keys and the processor may be configured to encrypt with one key of the pair, data derived from at least two of the first part data, data relating to the source (SID) and data relating the article.

Yet further included within the scope of the present invention is a verifying device for cooperating with a transponder as hereinbefore defined, the verifying device comprising means for receiving the first response signal and reading the first part data and the second part data in the first response signal, a processor for extracting from the data the UID and a source identity code (SID), processing the second part data and extracting from the second part data, a calculated version of the first part data (UID′) and the source identification code(SID′).

The verifier device may comprise a comparator for comparing at least one of UID and UID′ on the one hand and SID and SID′ on the other; and an indicator for providing an indication when at least one of UID and UID′, and SID and SID′match.

Still further included within the scope of the present invention is an RFID system comprising a plurality of transponders as hereinbefore defined; a signer device for writing second part data to a selected transponder; and a verifying device.

Also included within the scope of the present invention is a method of tagging an article, the method comprising the steps of, at a source of the article, applying to the article a transponder comprising control circuitry, a response signal generating arrangement and a memory arrangement connected to the control circuitry, the memory arrangement comprising at least a first part and a second part, the first part comprising unique identification data (UID) relating to the transponder and which is permanently stored in the first part of the memory arrangement at manufacture of the transponder; and writing second part data to the second part of the memory arrangement, the second part data comprising data resulting from mathematical processing of at least two of the first part data, data relating to the source and data relating to the article.

Yet further included within the scope of the present invention is a method of reading a transponder comprising the steps of causing the transponder after being exposed to an energizing signal automatically to transmit a first response signal comprising first part data relating to the transponder and permanently stored in a first part of a memory arrangement of the transponder at manufacture of the transponder and second part data subsequently written into the memory arrangement at a source of the article, the second part data comprising data derived from mathematical processing of at least two of the first part data, data relating to the source and data relating to the article; and receiving the first response signal at a reader and processing the first and second part data to confirm the authenticity of at least one of the transponder and the source.

### BRIEF DESCRIPTION OF THE ACCOMPANYING DIAGRAMS

The invention will now further be described, by way of example only, with reference to the accompanying diagrams wherein

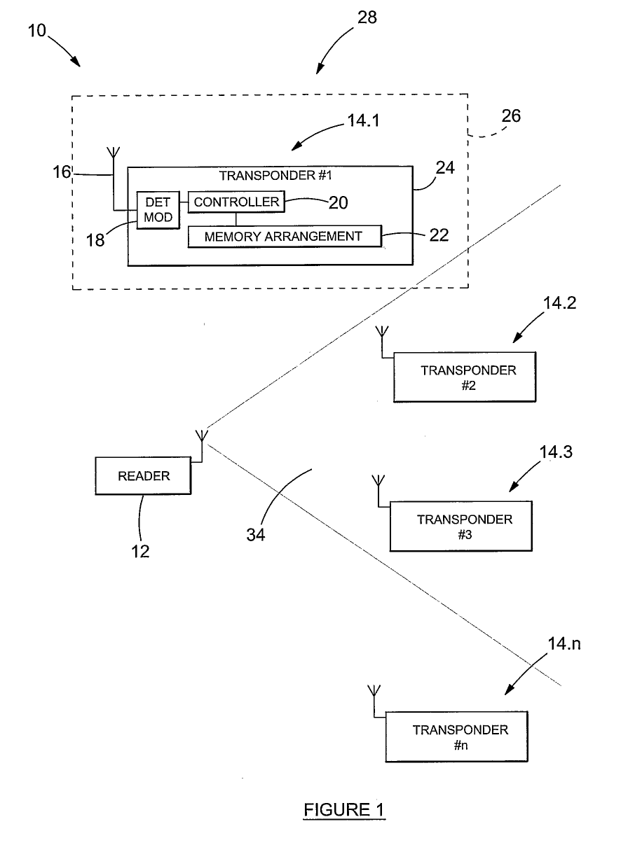

FIG. 1 is a block diagram of a radio frequency identification (RFID) system of the kind according to the invention;

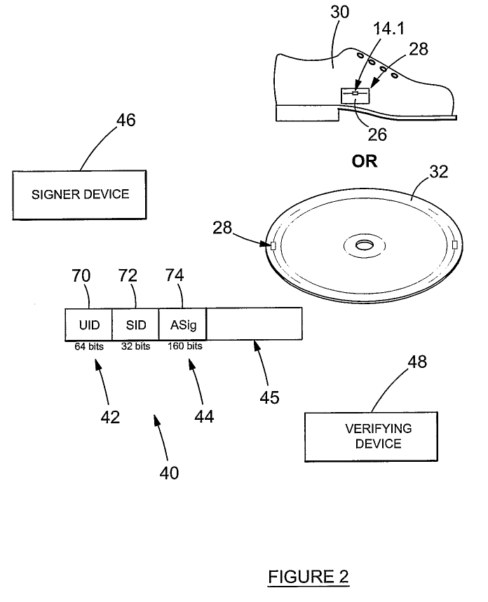

FIG. 2 is a diagram illustrating typical products or articles in respect of which the system may be used, as well as a signer device forming part of a system for tagging an article at a source and a verifying device for subsequently verifying the source of the product in an operational field; and

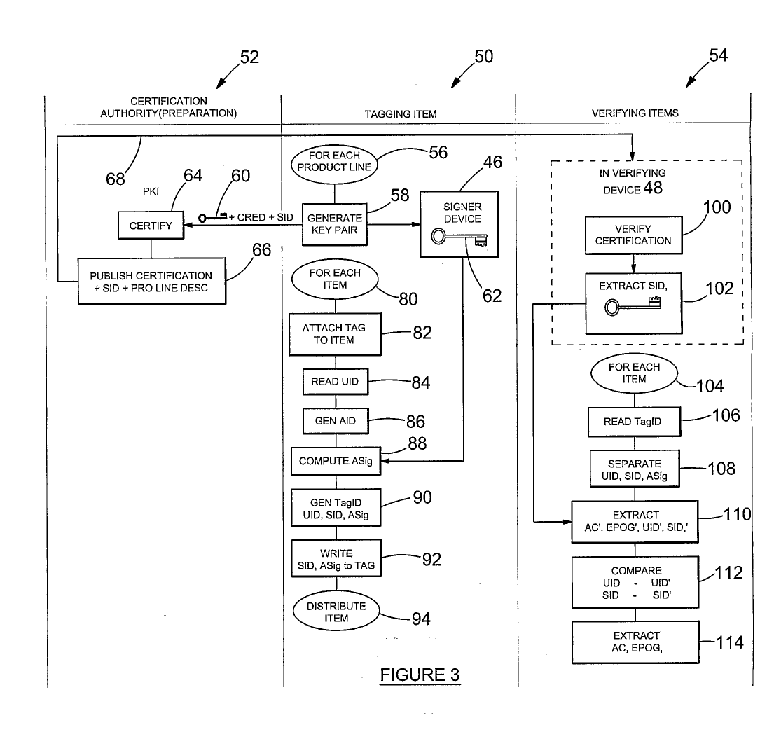

FIG. 3 is a diagram illustrating a method according to the invention of tagging an article at a source and subsequently verifying the source of the product.

### DESCRIPTION OF A PREFERRED EMBODIMENT OF THE INVENTION

A radio frequency identification (RFID) system according to the invention is generally designated by the reference numeral 10 in FIG. 1.

The system 10 comprises an energizer, interrogator and/or reader 12 and a plurality of transponders 14.1 to 14.n. The transponders are substantially similar and therefore only transponder 14.1 will be described in more detail hereinafter. Transponder 14.1 comprises an antenna 16, a signal detector and modulator 18, a controller 20 and a memory arrangement 22. The detector and modulator 18, controller 20 and memory arrangement 22 may be integrated on a semiconductor chip in the form of an application specific circuit (ASIC) 24. The chip 24 is connected to the antenna 16 to form the transponder 14.1. The transponder 14.1 is mounted on a substrate 26 to form a tag 28 which may be applied to a host article as will hereinafter be described.

Referring to FIG. 2, the tag 28 may be applied to any suitable product or article such as a shoe 30 or an optically readable data disc 32. In use, the transponders serve to identify the products or may be used to count a plurality of products carrying similar tags and/or to authenticate or verify a source of the products as will hereinafter be described, to distinguish genuine products from pirate or grey products.

In use, the reader 12 is used to broadcast an energizing signal 34. The transponders 14.1 to 14.n may be passive transponders configured in known manner to derive power from the signal. The transponders then automatically and after a respective hold-off period respond with respective first response signals. Each response signal comprises data stored in the memory arrangement 22 of the transponder. Various known schemes or protocols may be employed by the system to avoid collisions between respective response signals. In a preferred system, a so-called tag talks only (TTO) protocol is utilized, wherein at least during the initial stages of reading the transponders there is no handshaking between the reader 12 and the transponders 14.1 to 14.n and wherein the reader does not transmit data, prompt or interrogate the transponders. To avoid collisions between respective response signals, a system of variable inter-response signal waiting periods between successive response signals by a transponder is utilized. Such a system is disclosed in the applicant's U.S. Pat. No. 6,154,136 and the contents thereof are incorporated herein by this reference.

The reader, in use, sequentially latches onto one of the transponders, receives the respective first response signal and reads the data carried thereby. The data is used for one or more of counting the article, identifying the article and authenticating an alleged or claimed source of the article. The problems with the currently known systems are set out in the introduction of this specification.

In FIG. 2 there is shown a data map 40 of the memory arrangement 22 of the transponder. The memory arrangement comprises a first part 42 wherein first part data in the form of a chip ID or UID is permanently written into and stored at manufacture of the ASIC 24. The UID may typically be locked into, or burnt, such as laser burnt, into the first part of the memory arrangement of the chip, or otherwise permanently recorded in the first part, so that any subsequent attempt to change the UID would result in permanent damage or destruction of the chip. Techniques are known to lock data permanently into EEPROM. This first part data can therefore not be changed at any stage of the operational life of the transponder. The first part data 42 may be 64 bits in length. The memory arrangement further comprises a second part 44 of 192 bits in length wherein second part data is at any time subsequent to manufacture, programmable or writeable by a user of the transponder 14.1, such as at a source of a host article 30 carrying the transponder 14.1, as will hereinafter be described. Thereafter this second part data is locked into the memory arrangement. Techniques for achieving this in EEPROM are known as stated hereinbefore. The memory arrangement 22 comprises a third part 45 wherein third part data may at any time after manufacture selectively be written into, read, unlimitedly rewritten, changed and/or amended. Third part data may be written into and read from the third part of the memory arrangement through an interrogation process by the reader acting as interrogator and according to any suitable protocol after the transponder has been identified from data in the first response signal as aforesaid and its ID and address are known by the reader. During this interrogation phase, data from the third part is transmitted to an external device, such as an interrogator (which may be integrated with the reader 12) as part of a second response signal.

The first, second and third parts of the memory arrangement 22 may be embodied in a single block or body of EEPROM memory.

The second part data is written into the second part by a computerized signer device 46 associated with and located at a tagging station at the source of the articles 30,32. A computerized verifying device 48, which may be portable, is used in an operational field or supply chain to use the aforementioned data to verify offline the source authenticity of articles carrying transponders as will herein be described. The verifying device 48 may be used by retailers, warehouse managers and in-the-field inspectors or agents of the source.

Referring now to FIG. 3, the centre column 50 relates to activities at the source or tagging station, column 52 relates to activities at a known certification authority (CA) forming part of a known public key infrastructure (PKI) and column 54 relates to activities in the field at a verification station where the offline verification is performed. As shown at 56 and at the source, for each product line originating at said source, an encryption key pair generator of a processor in the signer device 46 is utilized to generate at 58 in known manner an asymmetrical encryption key pair comprising a public key 60 and a private key 62. The private key is kept secret and remains stored in a memory arrangement of the signer device. The public key is communicated together with a source identification code (SID) and required credentials to the CA. The CA certifies the public key at 64 and publishes at 66 a certificate comprising the public key, SID and product line description; This certificate is accessible by authorized parties from the PKI. It is also forwarded at 68 to the verifying devices 48 in the field.

Referring again to the data map 40 in FIG. 2. The UID 70 is a unique number permanently stored in the first part of the memory arrangement as stated hereinbefore. The SID 72 is a 32 bit source identification code. This code identifies the source, but more importantly, the asymmetric key pair generated by the signer device 46 as hereinbefore described. The SID may be secret or published. An Asig 74 is a 160 bit asymmetric cipher text code representing an article code (AC). The Asig has meaning only once decrypted with the SID referenced public key 60 as will hereinafter be described. The SID 72 and/or Asig 74 are write-once or one-time-programmable only into the second part 44 of the memory arrangement as hereinbefore described, to prevent code tampering. The Asig is generated as hereinafter described.

During tagging of an article and starting at 80, a tag is attached to each article at 82. The UID 70 is read at 84 to be used by the processor in the signer device 46 in computing the Asig 74. At 86, the AC is determined or generated. The AC may be an EPC code or a VIN code for vehicle applications. In the case of other articles, the AC may comprise a digitised version of a feature unique to the article, such as a digital image of part of the article or a hash of digital content thereof in the case of digital data carrying devices, such as optically readable data discs. Thereafter, a 96 bit article identification code (AID) is generated according to the following:
AID=Combine(Concatenate((UID,SID), AC) ______ A
   The combine operation is performed by using a reversible transform to allow the recovery of data.

Thereafter, a 160 bit scrambled AID (sAID) is generated using a reversible RandomExpand function that combines the AID and padding data (e.g. a TimeStamp and random padding) according to the following:
sAID=RandomExpand(AID, TimeStamp, RandomPad) ______ B

Thereafter, at 88, the 160 bit Asig is computed by an asymmetric private key cryptographic signing of the sAID according to the following:
Asig=AsymmetricEncrypt(RandomExpand(AID),SourcePrivateKey) ______ C

The aforementioned TimeStamp may relate to time at the instance of encrypting or signing or another date and/or batch code. The TimeStamp may be a 32 bit epoch as defined by ANSI.

A TagID comprising the UID 70, SID 72 and Asig 74 is then generated at 90. Thereafter and at 92, the SID and Asig are written or programmed into the aforementioned second part 44 of the memory arrangement 22. The articles 30 carrying the tags 28 with TagID 70,72,74 as generated as aforesaid, is then distributed by the source in the supply chain as shown at 94.

Subsequent and in-the-field verification of the TagID is illustrated in column 54 in FIG. 3. Prior to any verification, the verifying device 48 receives the certificate, SID and public key 60 from the CA. The device verifies the certificate at 100 and extracts at 102 the SID and public key.

While offline at a verification station and at 104, for each item, the verifying device 48 reads at 106 the TagID in well-known manner by energizing the transponders on the tags. The control circuitry 20 on the transponder causes the response signal generator 18 automatically to generate after a respective hold-off period a first response signal comprising the aforementioned TagID. The verifier receives the first response signal and reads the TagID data and inputs the data.

The system 10 uses a transponder talks only (TTO) protocol while the verifying device reads this data, thereby reducing possible reader interference in applications where more than one reader and/or verifying device are used. Furthermore, this protocol is also believed to be more time and bandwidth efficient than handshaking and other know protocols. Intelligence on the verifying device verifies the TagID and determines appropriate actions based on the verification.

The verification steps are as follows. At 108, a processor of the verifying device 48 separates the UID part 70, the SID part 72 and the Asig part 74 of the TagID received. By using the SID, the appropriate public key 60 is retrieved from the memory arrangement of the device 48. The public key is used by the processor to decrypt the received Asig part as follows:
(AID′,epoch′)=RandomShrink(AsymmetricEncrypt(Asig,Source PublicKey)) ______ D
where
RandomShrink is the reverse function of RandomExpand in B and which yields a 96 bit calculated AID′ and calculated TimeStamp′.

The AID may be kept secret by keeping the SourcePublicKey 60 secret. In practice this is relatively easily achieved, since the SourcePublicKey is loaded only once and then retained in the memory of the device 48. The key needs not be communicated out of the device.

By reversing at 110 the step designated A hereinbefore, the following are calculated by the device; a UID′, SID′, and AC′ from AID′ and the epoch′.

At 112, UID′ and UID are compared to one another. If they compare, then the tag 28 and code 70, 72, 74 have not been tampered with and the SID claimed source is authentic. This also indicates that the AC′ and the epoch′ are the true values.

The TimeStamp may provide an additional test against cloning in that an encryption key validity period may be specified. The period may be communicated as part of the certificate published or made available by the CA.

Furthermore, an AC may be computed at the verifying device 48 in a manner similar to that described hereinbefore in respect of the signer device and then compared to AC′ obtained from the step 110 hereinbefore. If AC and AC′ do not compare, then the article is not represented by the tag and the article may be a pirate version or the article has been tampered with.

As stated hereinbefore, the third part 45 of the memory arrangement 22 may be utilised to write data to and read data from the transponder at any stage after manufacture of the transponder. This data may be read and written by any suitable interrogation protocol between an interrogator and the relevant transponder.

1. A transponder of a radio frequency identification (RFID) system, the transponder comprising control circuitry, a response signal generating arrangement and a memory arrangement connected to the control circuitry; the memory arrangement comprising at least a first part and a second part; the first part comprising unique identification data (UID) relating to the transponder and which is permanently stored in the first part of the memory arrangement at manufacture of the transponder; the second part being configured to be written to, after manufacture of the transponder; and the control circuitry being configured after energization of the transponder, to cause the response signal generating arrangement to generate a first response signal modulated with data comprising data in the first part and data in the second part, to be transmitted by the transponder.

2. A transponder as claimed in claim 1 wherein the transponder is a passive transponder, which in use derives power to energize the transponder from an energization signal transmitted by a reader of the RFID system.

3. A transponder as claimed in claim 2 wherein the control circuitry is configured, after energization by the energization signal, automatically to cause the first response signal to be transmitted, without the transponder being interrogated by the reader.

4. A transponder as claimed in claim 1 wherein the memory arrangement is configured such that any effort subsequently to change data in the first part, would result in the transponder being damaged.

5. A transponder as claimed in claim 1 wherein the memory arrangement comprises a third part for storing third part data which is not transmitted in the first response signal.

6. A transponder as claimed in claim 5 wherein the third part is configured to be read and repeatedly to be rewritten to.

7. A transponder as claimed in claim 6 wherein the control circuitry is configured to write data received from an external device to the third part of the memory arrangement; and in response to an interrogation signal received from an external interrogating device, to cause a second response signal comprising data retrieved from the third part to be transmitted.

8. A transponder as claimed in claim 1 wherein the first and second parts of the memory arrangement are embodied in a single body of EEPROM.

9. An RFID system comprising a plurality of transponders as claimed in claim 1; and a signer device which is utilized at a source of an article carrying one of the transponders to write into the second part of the memory arrangement second part data.

10. An RFID system as claimed in claim 9 wherein the second part data comprises data resulting from mathematical processing at least two of the first part data; data relating to the source; and data relating to the article.

11. An RFID system as claimed in claim 10 wherein the processing comprises encryption utilizing one key of an encryption key pair.

12. An RFID system as claimed in claim 11 wherein the data relating to a source may be a source identification code (SID) and wherein the SID is linked to the encryption key pair.

13. An RFID system as claimed in claim 10 wherein the data relating to the article comprises at least one of an electronic product code (EPC), a vehicle identification number (VIN) and digital data relating to a unique feature of the article.

14. An article tagging station at a source of an article to be provided with a transponder as claimed in claim 1, the station comprising a signer device comprising a processor for generating second part data and writing the second part data into the second part of the memory arrangement of the transponder.

15. An article tagging station as claimed in claim 14 wherein the processor comprises an encryption key pair generator for generating a pair of encryption keys; and wherein the processor is configured to encrypt with one key of the pair data derived from at least two of the first part data, data relating to the source (SID) and data relating the article.

16. A verifying device for cooperating with a transponder as claimed in claim 1, the verifying device comprising means for receiving the first response signal and reading the first part data and the second part data in the first response signal, a processor for extracting from the data the UID and a source identity code (SID), processing the second part data and extracting from the second part data, a calculated version of the first part data (UID′) and the source identification code (SID′).

17. A verifying device, as claimed in claim 16 comprising a comparator for comparing at least one of UID and UID′, SID and SID′; and an indicator for providing an indication when at least one of UID and UID′ and SID and SID′ match.

18. An RFID system comprising a plurality of transponders as claimed in claim 1; a signer device for writing second part data to a selected transponder; and a verifying device.

19. A method of tagging an article, the method comprising the steps of, at a source of the article, applying to the article a transponder comprising control circuitry, a response signal generating arrangement and a memory arrangement connected to the control circuitry, the memory arrangement comprising at least a first part and a second part, the first part comprising unique identification data (UID) relating to the transponder and which is permanently stored in the first part of the memory arrangement at manufacture of the transponder; and writing second part data to the second part of the memory arrangement, the second part data comprising data resulting from mathematical processing of a least two of the first part data, data relating to the source and data relating to the article.

20. A method of reading a transponder comprising the steps of causing the transponder after being exposed to an energizing signal automatically to transmit a first response signal comprising first part data relating to the transponder and permanently stored in a first part of a memory arrangement of the transponder at manufacture of the transponder and second part data subsequently written into the memory arrangement at a source of the article, the second part data comprising data derived from mathematical processing of at least two of the first part data, data relating to the source and data relating to the article; and receiving the first response signal at a reader and processing the first and second part data to confirm the authenticity of at least one of the transponder and the source.
